(19) United States
(12) Patent Application Publication
(10) Pub. No.: US 2009/0260283 A1
(43) Pub. Date: Oct. 22, 2009

(54) Fertilizer spike injection tool

(76) Inventor: George B.F. Blake, Newmarket (CA)

Correspondence Address: George B. F. Blake, 1116 Far North Circle, Newmarket, ON, L3X1N5, CA

(21) Appl. No.: 12/148,018

(22) Filed: Apr. 17, 2008

(51) Int. Cl. A01G 29/00

(52) U.S. Cl. 47/48.5

(57) ABSTRACT

A fertilizer spike injection tool, specifically adapted with a ground-penetrating member end for forming a solid fertilizer spike-receiving cavity in the ground for tree and plant root nutrition with a tamper end adapted to set the fertilizer spike to the depth of the particularly dimensioned formed ground cavity so created by the ground forming member. The tool has a handle for placing the device on the ground, for standing operation, and a foot bar, for easing the tool into the ground using both feet.

### CROSS REFERENCE TO RELATED APPLICATIONS

Not Applicable

### FEDERALLY SPONSORED RESEARCH

Not Applicable

### DESCRIPTION OF ATTACHED APPENDIX

Not Applicable

### FIELD OF THE INVENTION

This invention falls within the general field of gardening tools and pertains specifically to a compound hand-held fertilizer spike tool for the injection of solid fertilizer spikes into the soil for tree and plant root nutrition which combines the function and structure of a tool for forming a solid fertilizer spike-receiving cavity in the ground with a tool structured for tamping the fertilizer spike to the depth of a ground cavity.

### BACKGROUND OF THE INVENTION

The benefits of fertilizer; free-flowing granular and molded fertilizer spikes, for providing nutrients for trees and shrubs directly below the ground surface are known. Free-flowing granular fertilizer molded into a solid fertilizer spike was introduced as a means to provide uniform slow-release fertilizer compositions and at a lower cost from mass production. Longstanding fertilizer spikes are driven into the ground by getting down on your hands and knees, placing a plastic cap on top of the fertilizer spike and then hold the fertilizer spike in one hand while repeatedly hitting the top of the fertilizer spike with a hammer held in the other hand. This requires hammering the fertilizer spike hard enough and long enough to ensure that the fertilizer spike is injected into the soil deep enough below-grade to avoid grass burn. To avoid damaging both your hand and the fertilizer spike, it is required that the fertilizer spike and the plastic cap be held by hand—intact and in-place, until the fertilizer spike was fully injected into the soil. After the fertilizer spike is injected to the desired depth, the plastic cap must be dugout the debris removed from the plastic cap and hammer so they could be used to inject the next fertilizer spike. Injecting, on average, 5 fertilizer spikes per tree, several times per year, this procedure was laborious, time-consuming and accident-prone as well as hard on ones back and knees.

Prior art to introduce free-flowing granular fertilizer and fertilizer spikes into the soil by hole making tools; by either earth removal or earth compaction, coupled with attachments are known, as well as numerous other prior art within the general field of hand-held gardening tools which share the principles of making holes in the ground by either earth removal or earth compaction include tools used to: drive or set poles or survey stakes, set plants, remove and/or replace a plug of ground or sod or remove weeds as well as those tools used for ground aeration. The object of the new invention, by departing from the conventional concepts and designs of the prior art, is to provide a less costly, safe and simple to use tool for effecting the placement of a fertilizer spike to the desired depth below-grade from a standing position.

### DESCRIPTION OF THE PRIOR ART

Prior art to introduce free-flowing granular fertilizer into the soil by hole making tools by earth removal disclosed in U.S. Pat. Nos. 6,076,300, 5,558,030 5,487,236 5,105,578 4,246,854 and 2,857,864—having numerous operational differences; namely, the retention of the fertilizer within the tool prior to ejection as well as auxiliary and/or moving parts, disclose numerous and obvious structural differences compared to the new invention. Additionally, U.S. Pat. No. 3,113,534—operational different than the new invention, discloses a process comprising the removal of soil and a tool having a cutting end and an open-end whereby the core of soil may be delivered back to the hole in the ground and further comprises forming a hole 12 to 24 inches deep by removing an earth core and as such, the prior art discloses numerous and obvious structural differences compared to the new invention.

Prior art to introduce free-flowing granular fertilizer into the soil by hole making tools by earth compaction disclosed in U.S. Pat. Nos. 4,123,980 and Des. 389,705—having numerous operational differences; namely, the retention of the fertilizer within the tool prior to ejection as well as auxiliary and/or moving parts, disclose numerous and obvious structural differences compared to the new invention. U.S. Pat. No. 3,838,739—discloses a process and tool for making small, circularly-deep holes comprising of a stake-like point at one end, with an accompanying pair of transverse foot rests and a stake-like point at the opposite end, with an accompanying pair of transverse foot rests for penetration of the ground into the soil and as such, discloses numerous and obvious structural differences compared to the new invention.

Prior art to introduce fertilizer spikes into the soil by hole making tools by earth compaction disclosed in U.S. Pat. Nos. 7,252,042 B1 6,843,020 B2 5,461,992 4,676,538 and 3,903,815—having numerous operational differences; namely, the retention of the fertilizer within the tool prior to ejection as well as auxiliary and/or moving parts, disclose numerous and obvious structural differences compared to the new invention. Additionally, U.S. Pat. No. 3,892,552 issued to Jacob Douglas Gay, Jr., on Jul. 1, 1975 discloses a molded rubber or plastic protective cap for driving wedge-shaped fertilizer spikes into soil with a hammer rather than injecting fertilizer spikes in it's own right and as such has numerous and obvious structural and operational differences compared to the new invention. Also, U.S. Pat. No. 3,290,821—operational different than the new invention, discloses a process and tool comprising of a stake at one end and a spike at the opposite end for a hollow core tube-like fertilizer, not solid spike-like fertilizer, which is slip-fitted over the spike-end of the tool for injection into the soil and as such, discloses numerous and obvious structural differences compared to the new invention.

Other prior art within the general field of hand-held gardening tools which share the principles of making holes in the ground by either earth removal or earth compaction include tools used to: drive or set poles or survey stakes, set plants, remove and/or replace a plug of ground or sod or remove weeds as well as those tools used for ground aeration and general-purpose earth working tools such as picks and flat blade spades or shovels.

Prior art related to holes by earth compaction such as those used to drive or set poles or survey stakes disclosed in U.S. Pat. Nos. 4,813,494 4,101,088 2,629,985—having numerous operational differences; namely, the retention of a spike within the tool prior to ejection as well as auxiliary and/or moving parts, disclose numerous and obvious structural differences compared to the new invention.

Prior art related to holes by earth compaction such as those used to set plants as disclosed in U.S. Pat. No. 6,892,823—discloses a process and tool for providing a recess in the ground by twisting a hollow, rectangular earth separating member 1800 when in the ground and comprises a T-type handlebar at the upper end to facilitate the twisting process and a hollow triangular body defining an earth separating member and as such, discloses numerous and obvious structural differences compared to the new invention. Additionally, U.S. Pat. No. 6,047,651 discloses a device having interchangeable earth piercing tips, and a process for using such tips, for forming holes of different sizes and comprises a cylindrical post having an upper end with a handle coupled thereto including a U-shaped support with a gripping bar and a small hole digging attachment with a cylindrical configuration and a threaded outer periphery and as such, discloses numerous and obvious operational and structural differences compared to the new invention. Similarly, U.S. Pat. No. 5,492,070 discloses a device having interchangeable earth piercing tips, and a process for using such tips, for forming holes of different sizes for planting potted nursery plants and comprises of a handle member slidably extendable and a punch head being removably connected and as such, discloses numerous and obvious operational and structural differences compared to the new invention. Further, U.S. Pat. No. 5,228,400 discloses a tool for planting bedding plants and bulbs and comprises of a stirrup-shaped bracket for a single foot of a person and a conical portion for making circular holes is connected to the stirrup-shaped bracket and as such, discloses numerous and obvious operational and structural differences compared to the new invention. U.S. Pat. No. 5,080,027 discloses a device having interchangeable earth piercing tips, and a process for using such tips, for forming holes of different sizes for planting seeds and small plants and comprises a T-type handlebar at the upper end to facilitate the twisting process, a solid circular body defining an earth separating member comprising a threaded opening at the lower end and a single-foot side bar for foot power and as such, discloses numerous and obvious structural differences compared to the new invention. U.S. Pat. No. 2,207,741—discloses a process and tool for providing a recess in the ground and additional root pocket to be filed with soil to embed the rots of the plant and comprises a hollow cone having a base of greater diameter than the depth of the cone, a narrow pin secured to the apex of the cone and lacking a foot bar, applies downward force using a handle exclusively and as such, discloses numerous and obvious structural differences compared to the new invention. U.S. Pat. No. 1,498,623—discloses a tool to facilitate the planting of small plants and comprises a rod pointed at it's lower end and a hand-hold formed at the opposite end, an adjustable foot rest on the rod, and punches a small round hole and as such, discloses numerous and obvious structural differences compared to the new invention.

Prior art which make holes in the ground by removal and/or replacement of ground, sod, plant or weed disclosed in U.S. Pat. Nos. 6,386,294 6,138,589 5,469,923 5,398,624 5,234,241 5,005,888 4,974,682 4,932,339 4,884,638 4,715,634 4,585,072 4,191,116 3,927,720 3,444,938 3,416,831 3,210,112 2,030,770 2,028,483 1,783,026 and 772,097—having numerous operational differences; namely, auxiliary and/or moving parts, disclose numerous and obvious structural differences compared to the new invention. Additionally, U.S. Pat. Nos. 4,209,903 2,210,440 Des. 423,889 and Des. 251,698—operational different than the new invention, discloses a process and tool for cutting and removing grass comprising of a cross-member handle at one end and open-ended circular or square cutting cylinder at the opposite end for making the hole, and as such, discloses numerous and obvious structural differences compared to the new invention.

Prior art which make holes in the ground for ground aeration disclosed in U.S. Pat. Nos. 5,088,562 4,819,735 3,830,310 3,170,422 3,163,456—having numerous operational differences; namely, auxiliary and/or moving parts, disclose numerous and obvious structural differences compared to the new invention.

Prior art related to making holes in the ground which are general-purpose earth working tools such as picks and flat blade spades or shovels, result in the disadvantage of difficult, complex, awkward or supplemental procedures to size the hole suitable for a fertilize spike compared to the new invention. U.S. Pat. No. 5,669,649—having numerous operational and design differences; namely, flat plate digging elements, discloses numerous and obvious structural differences compared to the new invention. Additionally, U.S. Pat. No. 5,109,930 discloses a hand and foot powered tool for making furrows in soil suited for construction and comprises a handlebar at the upper end to facilitate the twisting process and a flat wedge-shaped blade body defining an earth splitting member at the opposite end and as such, discloses numerous and obvious structural differences compared to the new invention. U.S. Pat. No. 1,757,925 discloses a device having interchangeable earth piercing tips, and a process for using such tips, for forming holes for surveying purposes and comprises a staff with a removable handle the upper end and a flat, thin blade body defining an earth splitting member—interchangeable with a cone-like tip for making small circular holes, at the opposite end and as such, discloses numerous and obvious structural differences compared to the new invention. Similarly, U.S. Pat. No. 1,464,353 discloses a device having interchangeable earth piercing tips, and a process for using such tips, for forming holes for post holes and comprises interchangeable screw-fitted handle sections and a U-shaped blade in cross section body defining an earth removing member with a screw-threaded portion and lacking a crossbar for foot power, discloses numerous and obvious structural differences compared to the new invention. U.S. Pat. No. 1,323,630—discloses a Trench-Pick and comprises a D-type handle grip at the upper end which is turned outwardly and downwardly at it's lower end, a single-foot power means and punches a small round hole and as such, discloses numerous and obvious structural differences compared to the new invention. U.S. Pat. No. 385,324—discloses a process and tool for planting hedge fences and comprises a D-type handle grip at the upper end to facilitate the two sidewise motions of the digging process and a long diamond-shaped, in cross section, body defining an earth separating member. U.S. Pat. No. Des. 339,038—discloses a process and tool for providing a recess in the ground by twisting a flat, triangular earth separating member 180° when in the ground and comprises a D-type handle grip at the upper end to facilitate the twisting process and a flat triangular body defining an earth separating member and as such, discloses numerous and obvious structural differences compared to the new invention.

The aforementioned prior art sited within the general field of hand-held gardening tools that share the principles of making holes in the ground by either earth removal or earth compaction, including those tools sited that relate specifically to fertilizer spikes, differ in function and design in comparison to the new invention wherein the prior art: is more costly to manufacture; requires greater operator time, energy or effort; involves uncomfortable/unstable/off-balance or unsafe operation; requires excessive step-up height to the foot bar; involves difficult, complex, awkward or supplemental procedures to size the hole suitable for a fertilize spike and/or special expertise to inject a fertilizer spike into the soil and/or to remove the tool from the soil while leaving the fertilizer spike behind; risks inadvertent displacement of the fertilizer spike during injection; and/or requires ongoing replacement and maintenance of a striker pad or rubber cushion.

In these respects, the fertilizer spike tool according to the new invention substantially departs from the conventional concepts and designs of the prior art, and in so doing provides a novel compound tool, operable in an standing position, which combines the function and structure of a tool developed for the purpose of forming a particularly dimensioned cavity in the ground to the desired depth below-grade for receiving a solid fertilizer spike for tree and plant root nutrition with a tool structured for tamping the fertilizer spike to the depth of a ground cavity.

### BRIEF SUMMARY OF THE INVENTION

The new invention substantially provides a novel compound tool developed for the injection of solid fertilizer spikes into the soil by forming a particularly dimensioned cavity in the ground to the desired depth below-grade for receiving a solid fertilizer spike for tree and plant root nutrition with a tool structured for tamping the fertilizer spike to the depth of a ground cavity which is less costly to make and which is safe and simple to use in the standing position.

As shown in FIG. 1, the new invention comprises a handle for using the tool in a standing position, a ground-penetrating member to form a particularly dimensioned cavity in the ground for receiving a solid fertilizer spike, a foot bar to apply power from both feet to inject the tool into the ground to form the cavity and a closed blunt top end of the handle adapted to tamp the fertilizer spike to the cavity bottom after hand-placing the fertilizer spike into the formed cavity. The handle is a rigid, linear, elongated, tubular shaft approximately 45 inches in length and approximately 1 inch in diameter. The ground-forming member consists of ground-penetrating wedge-like member having an upper section of an elongated body that is substantially elongated hexagonal-shaped in cross-section with diametric widths of approximately 1 inch and 1½ inch, a lower section that tapers from the upper section to a sharpened closed end and a combined diametric length of the integrated upper and lower sections of approximately 8 inches is, at the upper section, perpendicularly fixed and concentric to the underside of said foot bar.

In use, the gardener grasps the tool at the upper end of the handle then sets the ground-penetrating end point into the ground, first, with the handle held perpendicular to the ground, by applying downward pressure with the handle in a spear-like fashion, then by applying downward pressure with both feet on the foot bar. A solid fertilizer spike cavity is formed when the underside of the foot bar meets the ground whereupon the tool is withdrawn from the ground by the gardener pulling upward on the handle. By turning the tool end for end, the gardener then uses the closed blunt end of the handle to tamp the fertilizer spike to the cavity bottom after hand-placing the fertilizer spike into the formed cavity.

### BRIEF DESCRIPTION OF THE DRAWINGS

The same reference numerals refer to the same parts throughout the various Figures.

FIG. 1 is a side view of the fertilizer spike tool in accordance with this new invention.

FIG. 2 is a front view of the fertilizer spike tool.

FIG. 3 is a top-down view of the fertilizer spike tool.

FIG. 4 is a bottom-up view of the fertilizer spike tool.

FIG. 5 is a perspective view of the ground-forming member portion of the fertilizer spike tool.

FIG. 6 is a partial operational front view of the fertilizer spike tool showing the ground-penetrating member fully inserted into the ground.

FIG. 7 is a partial operational front view of the fertilizer spike tool showing the ground-penetrating member fully removed from the ground leaving the fertilizer spike-receiving cavity in the ground.

FIG. 8 is a partial operational view of the tamping end of the fertilizer spike tool along with the fertilizer spike having been hand-place into the fertilizer spike-receiving cavity in the ground.

FIG. 9 is a partial sectional front view of the fertilizer spike tool but constructed in accordance with an alternate embodiment of this new invention showing the handle fixed to the ground-penetrating member rather than to the foot bar.

### REFERENCE NUMERALS IN DRAWINGS

10 Complete Tool
11 Handle shaft
12 End Cap/Plug
13 Elongated hexagonal-shaped ground-forming member
14 Top of the elongated hexagonal-shaped ground-forming member
15 Ground engaging tip of the elongated hexagonal-shaped ground-forming member
16 Foot Bar
17a Foot Bar ledge at the front left
   b Foot Bar ledge at the front right
18a Flange of the Foot Bar—front left
   b Flange of the Foot Bar—front left
19 Underside of the foot bar flanges 18a and 18b
20 One-piece Unit including the Foot Bar 16 & Elongated hexagonal-shaped ground-forming member 13
21 Soil
22 Fertilizer Spike
23 Fertilizer spike-receiving cavity in the ground
24 Tamper End of the Tool

### DETAILED DESCRIPTION OF THE INVENTION

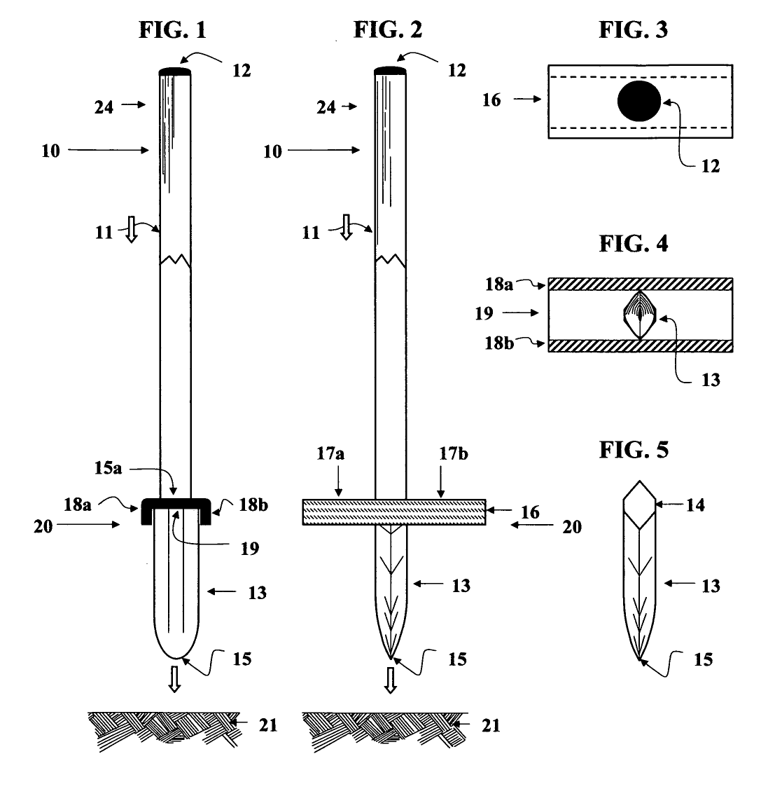

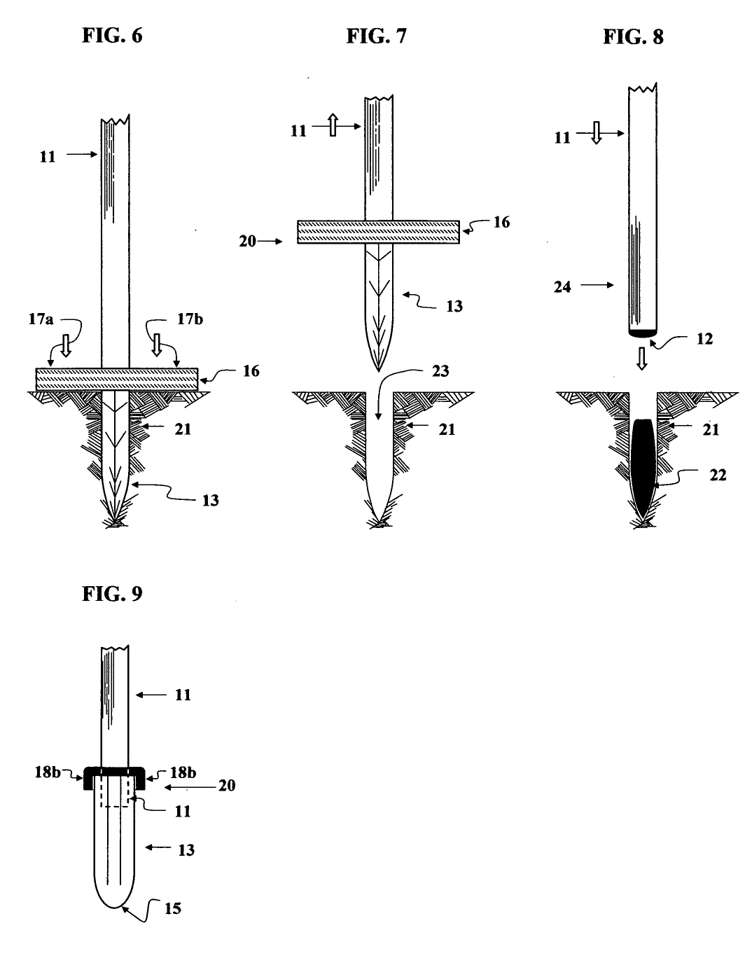

FIG. 1 shows a tool, designated generally as 10 in the drawings, specifically adapted with a ground-penetrating member 13 end for forming a solid fertilizer spike-receiving cavity in the ground 23 for tree and plant root nutrition and a tamper end 24 adapted to set the fertilizer spike to the depth of the particularly dimensioned formed ground cavity 23 so created by the ground forming member 13. The tool 10 consists of a rigid cylindrical tubular shaft handle 11 having upper and lower ends.

Shaft handle 11 is approximately 1 inch in diameter and 45 inches in length, onto which is connected; an end cap/plug 12 at the upper end adapted to form a blunt closed tamper end 24. a foot bar 16 perpendicularly fixed and concentric to the lower end and a ground-penetrating member 13 perpendicularly fixed and concentric to the underside of the foot bar 16. The rigid cylindrical shaft handle 11 is constructed of rigid hollow metal or plastic tubing or the like and may alternatively be constructed of solid wood wherein the tamper end 24 of shaft handle 11 is adapted as a tamper by machining rather than from the use of an end cap/plug 12.

The foot bar 16, as shown, consists of foot bar flanges 18a and 18b and subsequent foot ledges 17a and 17b, collectively referred to as the foot bar 16, are in the form of an inverted “U” shaped channel member made of steel, sheet metal or the like, approximately 9″ long, 1½″ wide and 1¼″ deep is perpendicularly fixed and concentric to the lower end of the handle 11. Alternatively, the foot bar 16 may be constructed of tubular, flat or cast steel.

The ground-penetrating member 13, perpendicularly fixed and concentric to the underside of the foot bar 16, is a one-piece wedge-like member comprised of integrated upper and lower sections. The upper section consists of an elongated body that is substantially elongated hexagonal-shaped in cross-section with diametric widths of approximately 1 inch and 1½ inch. The lower section tapers from the upper section to a sharpened closed end 15. The combined diametric length of the integrated upper and lower sections of the ground-penetrating member 13 is approximately 8 inches. The ground-penetrating member 13 may be constructed by either the tool and die stamping of sheet metal, aluminium or by cast steel.

Alternatively the foot bar 16 may be integrated with the ground-penetrating member 13 as a unit 20 when formed by either the tool and die stamping of sheet metal, aluminium or by cast steel.

In an alternate embodiment of the invention, as shown in FIG. 9, the handle 11 may extend, at the lower end, perpendicularly through and beyond the foot bar 16 into a central accommodating aperture in the top of the upper section of the ground-penetrating member 13 and to be fixed thereto by force-fit, screw or threaded coupling.

1. A tool for the injection of solid fertilizer spikes into the soil for tree and plant root nutrition which combines the function and structure of a tool for forming a solid fertilizer spike-receiving cavity in the ground with a tool structured for tamping the fertilizer spike to the depth of a ground cavity, comprising:
a rigid elongated cylindrical shaft handle having an upper end and a lower end;
a closed upper end of said shaft handle adapted for tamping a fertilizer spike;
a foot bar perpendicularly fixed to the lower end of said elongated cylindrical shaft handle such that a foot ledge extends equally on each side therefrom said elongated cylindrical shaft handle so as to provide a platform against which a person exerts force with both feet simultaneously;
a ground-penetrating wedge-like member having an upper section of an elongated body that is substantially elongated hexagonal-shaped in cross-section with diametric widths of approximately 1 inch and 1½ inch, a lower section that tapers from the upper section to a sharpened closed end and a combined diametric length of the integrated upper and lower sections of approximately 8 inches is, at the upper section, perpendicularly fixed and concentric to the underside of said foot bar;

2. A tool for the injection of solid fertilizer spikes into the soil for tree and plant root nutrition which combines the function and structure of a tool for forming a solid fertilizer spike-receiving cavity in the ground with a tool structured for tamping the fertilizer spike to the depth of a ground cavity, comprising:
a rigid elongated cylindrical shaft handle having an upper end and a lower end;
a closed upper end of said shaft handle adapted for tamping a fertilizer spike;
a foot bar, having an aperture centrally located mid-length to accommodate the lower end of said elongated cylindrical shaft handle such that said elongated cylindrical shaft handle extends perpendicularly through and beyond said foot bar, extends equally on each side therefrom said elongated cylindrical shaft handle so as to provide a platform against which a person exerts force with both feet simultaneously;
a ground-penetrating wedge-like member having an upper section of an elongated body that is substantially elongated hexagonal-shaped in cross-section with diametric widths of approximately 1 inch and 1½ inch, a lower section that tapers from the upper section to a sharpened closed end and a combined diametric length of the integrated upper and lower sections of approximately 8 inches is, at the upper section, perpendicularly fixed and concentric to the underside of said foot bar;

3. A tool as in any of the preceding claims, wherein said foot bar may be integrated with said ground-penetrating member as a unit when formed by either the tool and die stamping of sheet metal, aluminium or by cast steel.

4. A tool as in penetrating claims 1, 2 or 3, wherein said elongated cylindrical shaft handle may be constructed of wood or metal and extend at the lower end extends perpendicularly through and beyond said foot bar into a central accommodating aperture in the top of the upper section of said ground-penetrating member and to be fixed thereto by force-fit, screw or threaded coupling.
